(19) United States
(12) Patent Application Publication
(10) Pub. No.: US 2015/0295826 A1
(43) Pub. Date: Oct. 15, 2015

(54) Offloading Packet Treatment using Modified Packet Headers in a Distributed Switch System

(71) Applicant: Aruba Networks, Inc., Sunnyvale, CA (US)

(72) Inventors: Sai Ganesh Sitharaman, Fremon, CA (US); Atul Moghe, San Jose, CA (US)

(73) Assignee: Aruba Networks, Inc., Sunnyvale, CA (US)

(21) Appl. No.: 14/249,157

(22) Filed: Apr. 9, 2014

(51) Int. Cl. H04L 12/801; H04L 12/825; H04L 12/721; H04L 12/851

(52) U.S. Cl. CPC H04L 47/12; H04L 47/24; H04L 47/25; H04L 45/44

(57) ABSTRACT

According to one embodiment, a method comprises an operation of receiving a packet with a packet header indicating that a first treatment is needed to be applied to the packet. The first treatment is applied and the packet header is modified to indicate that the first treatment is no longer needed to be applied to the packet. The packet is forwarded with the modified header.

### FIELD

Embodiments of the disclosure relate to the field of communications, and in particular, to a system, digital device and method that is directed to the managed distribution of communications.

### GENERAL BACKGROUND

In recent years, digital communications have become an essential function in virtually every digital device, ranging from miniature hand-held digital devices (e.g. cameras, dual-mode cellular telephones, etc.) to networking equipment (e.g. controllers, routers, etc.). For instance, digital devices may be connected to a local area network (LAN) through Ethernet adapters for wired network communications, or wireless adapters such as those operating according to the well-known IEEE 802.11a/ac/b/g/n standards. Such connectivity enables information to be communicated with other digital devices directly or indirectly connected to the LAN.

In a centralized communication scheme, information commonly in the form of “packets” is forwarded from a digital device connected to the network to another digital device that controls functionality of the network, referred to as a “controller”. Packet communications may be point-to-point, in which ingress packets are terminated at the controller, or carried out in a packet switching environment, in which the ingress packets in a given communication are terminated at the controller or are transient. Transient packets are packets that are received by the controller and are targeted to be forwarded to another device.

Switching platforms may be outfitted with enhanced capabilities compared to other switching platforms, such as firewall capabilities. These capabilities may include deep packet inspection, tighter session control and policing, and application visibility at a granular level among other capabilities. These enhancements may require extra cost that is not always needed within the particular switching platform. This can result in a non-uniform configuration when multiple modules are present that increases administration overhead and other costs.

### BRIEF DESCRIPTION OF THE DRAWINGS

The invention may best be understood by referring to the following description and accompanying drawings that are used to illustrate embodiments of the disclosure.

FIG. 1 is an exemplary embodiment of a network routing architecture incorporating a switching stack and a distribution switch.

FIG. 2 is an exemplary embodiment of switching units of a stack coupled together through a control plane and a shared object store system.

FIG. 3 is an exemplary embodiment of a switching unit incorporating a distributed access firewalling scheme.

FIG. 4 is an exemplary embodiment of a signaling sequence for configuring a network for distributed access firewalling.

FIG. 5 is an exemplary embodiment of a general flowchart for configuring a network for distributed access firewalling.

FIG. 6 is an exemplary embodiment of a specific flowchart for configuring a network for distributed access firewalling.

### DETAILED DESCRIPTION

Embodiments of the disclosure relate to a system, a digital device and method for distributed processing across multiple network devices. One example objective of distributed processing is to provide processing functionality for multiple network devices without providing processing functionality at each network device. Examples of processing functionality include firewalling. Firewalling functionality is referred to herein as an example for purposes of clarity, however, embodiments are applicable to any other functionality that may be distributed across multiple network devices.

The techniques described herein may be applied to a wide variety of different packet processing functionalities. These may include, without limitation, any one or more of the following: deep packet inspection for certain applications; encryption and decryption of AP (Access Point)/station tunnel traffic; fragmentation and reassembly of oversized packets; network authentication mechanisms that allow users to be authorized to access a system and that apply appropriate access control; and applying bandwidth contracts and rate limiting for certain types of traffic.

Embodiments of the disclosure relate to a system, a digital device and method for distributed access firewalling across multiple switching units. One example objective of distributed access firewalling is to provide firewalling for multiple switching units without providing firewalling capability at each switching unit.

Access firewalling on layer 2 and layer 3 access domains has been developed, in part, to provide tighter policy session control on access traffic. Such access firewalling may also make threats more visible, improve network address translation and allow for more granular policy control and structures. In this model, access switches at layer 2 and layer 3 are equipped with firewall capabilities. In some cases, switching platforms that have hardware-accelerated firewall capabilities can achieve deep-inspection, tighter session control and policing, and application visibility at a finer granular level. With a large number of access switches at layer 2 and 3, there may be many access switches that do not have hardware or software firewall capabilities. As a result, the network configuration is not uniform and additional administration overhead is required to ensure stability.

A distributed control plane mechanism may be used to optimally route packets across multiple access-switching units in a stack to available firewall modules. The routed packets may be limited to those that require firewall capabilities. The control plane mechanism may be configured to automatically detect the presence or absence of one or more firewall modules in a stack that are then used to enable stateful capabilities on users and interfaces.

The configuration and administration of the firewalls may be centralized on a stack primary. This allows the network to be configured and used in different locations, with different users, and with different interfaces in a stack. There is greater control of firewall knobs with less network configuration and less packet routing overhead. At the same time, the distributed mechanism allows for flexibility in deployments

A distributed mechanism, for example in software, may be used to detect and elect one of the access switch firewall modules as a configuration and administration active firewall module on the stack primary. This primary may be in a stacking system where session management occurs. The election may be based on various criteria including configured priority, number of hops from other members, stacking bandwidth along the path, etc.

Herein, certain terminology is used to describe features for embodiments of the disclosure. For example, the term “digital device” generally refers to any hardware device that includes processing circuitry running at least one process adapted to manage the flow of control traffic into the device. Examples of digital devices include a computer, a tablet, a laptop, a desktop, a netbook, a server, a web server, authentication server, an authentication-authorization-accounting (AAA) server, a Domain Name System (DNS) server, a Dynamic Host Configuration Protocol (DHCP) server, an Internet Protocol (IP) server, a Virtual Private Network (VPN) server, a network policy server, a mainframe, a television, a content receiver, a set-top box, a video gaming console, a television peripheral such as Apple® TV, a printer, a mobile handset, a smartphone, a personal digital assistant “PDA”, a wireless receiver and/or transmitter, an access point, a base station, a communication management device, a router, a switch, and/or a controller.

One type of digital device, referred to as a “controller,” is a combination of hardware, software, and/or firmware that is configured to process and/or forward information between digital devices within a network. According to one embodiment, the controller comprises a plurality of logic units that are adapted to manage ingress packets, one of these logic units being the control plane that processes control information used for the creation, operation, and management of the network.

It is contemplated that a digital device may include hardware logic such as one or more of the following: (i) processing circuitry; (ii) one or more communication interfaces such as a radio (e.g., component that handles the wireless data transmission/reception) and/or a physical connector to support wired connectivity; and/or (iii) a non-transitory computer-readable storage medium (e.g., a programmable circuit; a semiconductor memory such as a volatile memory such as random access memory “RAM,” or non-volatile memory such as read-only memory, power-backed RAM, flash memory, phase-change memory or the like; a hard disk drive; an optical disc drive; etc.) or any connector for receiving a portable memory device such as a Universal Serial Bus “USE” flash drive, portable hard disk drive, or the like.

Herein, the terms “logic” (or “logic unit”) and process” are generally defined as hardware and/or software. For example, as hardware, logic may include a processor (e.g., a microcontroller, a microprocessor, a CPU core, a programmable gate array, an application specific integrated circuit, etc.), semiconductor memory, combinatorial logic, or the like. As software, logic may be one or more software modules, such as executable code in the form of an executable application, an application programming interface (API), a subroutine, a function, a procedure, an object method/implementation, an applet, a servlet, a routine, source code, object code, a shared library/dynamic load library, or one or more instructions. These software modules may be stored in any type of a suitable non-transitory storage medium, or transitory computer-readable transmission medium (e.g., electrical, optical, acoustical or other form of propagated signals such as carrier waves, infrared signals, or digital signals).

The term “interconnect” is a communication path between two or more digital devices. The communication path may include wired and/or wireless segments. Examples of wired and/or wireless segments include electrical wiring, optical fiber, cable, bus trace, or a wireless channel using infrared, radio frequency (RF), or any other wired/wireless signaling mechanism.

The term “message” is a grouping of data such as a packet, a frame, a stream (e.g., a sequence of packets or frames), an Asynchronous Transfer Mode (ATM) cell, or any other series of bits having a prescribed format. Herein, a message comprises a control payload and a data payload. The control payload is adapted to include control information such as source and destination Internet Protocol (IP) addresses (e.g., IPv4 or IPv6 addressing), protocol, source and destination port information, and/or packet type.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Certain details are set forth below in order to provide a thorough understanding of various embodiments of the disclosure, albeit the invention may be practiced through many embodiments other that those illustrated. For instance, illustrative embodiments describe firewall functionality but other functionality may also be similarly shared. Such discussions are for illustrative purposes and do not preclude this invention from being conducted on messages having formats other than described. Also, well-known logic and operations may not set forth in detail in order to avoid unnecessarily obscuring this description.

### I. General Architecture

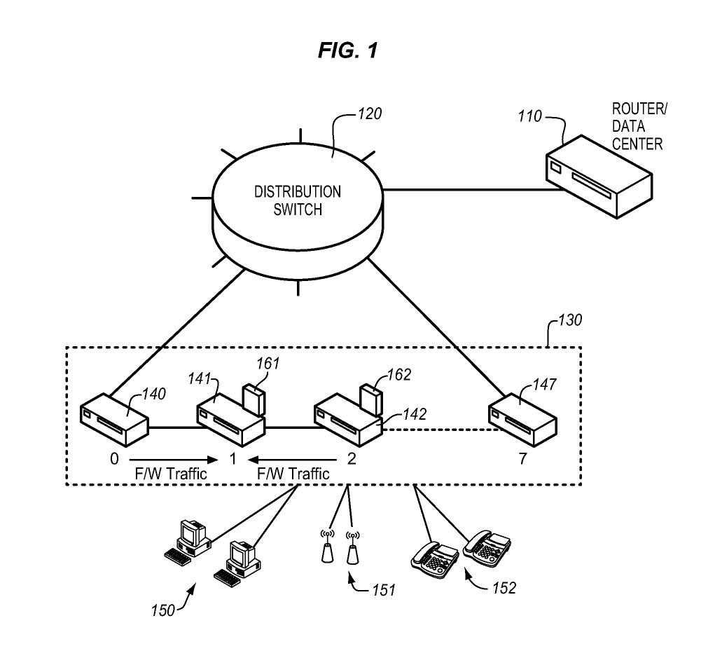

FIG. 1 is a diagram of a general packet processing and routing system architecture with multiple switching units to serve multiple clients in one or more switching domains. A router or data center 110 is coupled to or includes a distribution switch 120 that is coupled to one or more other data centers and domains for packet communication. The distribution switch has uplink and downlink trunks to connect with a switching stack 130 that contains multiple access switching units.

The stack is shown as having eight access switches 140, 141, 142 . . . 147, however there may be more or fewer, depending on the particular implementation. The access switches serve one or more external clients or client ports. In one example, each access switch includes 12 to 48 Gigabit Ethernet ports or a Wi-Fi interface. The switching stack 130 is coupled to any of a variety of different client end connections and types, such as trusted or untrusted user data, workstation, and computing terminals 150, wireless access points 151, and voice terminals 152. The end terminals may be connected directly through a single one of the access switches or indirectly through the stack 130.

Some of the access switches, in this case switches 1 and 2 also include additional services functionality. Not all of the access switches may require services functionality. In the exemplary embodiment, the services functionality is provided by an added services module 161, 162 in each switch. The additional module may be incorporated into the switch housing and switch hardware or it may be provided as an additional module in the same chassis or a separate chassis. In one embodiment, an ASIC (Application Specific Integrated Circuit) module may be added to one or more of the switches to suit traffic demands and cost constraints. The services module may provide any of a variety of different additional capabilities to the access switch. These capabilities may include better user and interface level policy session control on access traffic, better visibility, network address traversal, and granular AAA (Authentication, Authorization, and Audit) policies.

In order to better use the services capabilities of some of the services capable modules, the services capabilities may be made available to the other modules that do not have this capability. So, for example, module 0 or 7 may, when necessary, send packets to module 1 or 2 for inspection. After inspection, the packets may be returned to module 0 or 7 for further processing. This allows greater benefit to be obtained from just a few services modules.

A distributed control plane mechanism may be used to route the packets to an available services ASIC module within the stack. The control plane may be realized in one or more of the access switches 140 or it may be supported in another location. In one exemplary embodiment, the control plane automatically detects the presence or the absence of one or more services modules in the stack. The detected services modules are then used to enable stateful capabilities on users and interfaces. Configuration and administration of firewall and other capabilities may be centralized on a stack primary. This allows for a configure-once-use-anywhere approach across users and interfaces in a stack.

A distributed mechanism may be provided using functions in each access switch in cooperation with the control plane to detect and elect a centralized active services module in a stacking system where session management occurs. This mechanism may be provided with the ability to elect a services module based on various criteria including configured priority, the number of hops from other members of the stack, the stacking bandwidth along the path, etc.

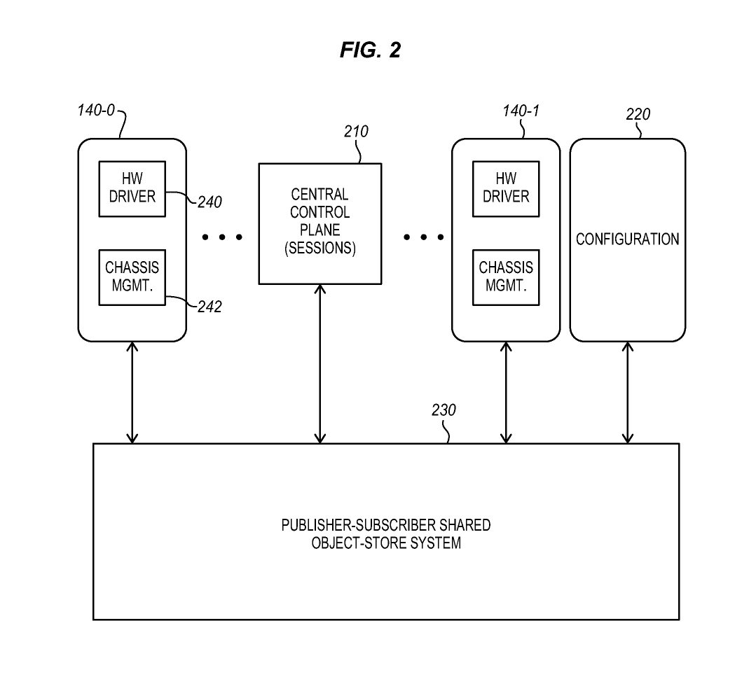

FIG. 2 is a diagram of access switches 140-0, 140-1 in a switching stack. Each access switch contains at least a hardware driver 240 for external packet processing and configuration and a chassis management infrastructure to detect configuration and advertise the configuration to the network. The access switches are coupled to together through a central control plane 210 that may run on an access switch or in some other device. The central control plane provides sessions for interactivity between the access switches.

The switches and the control plane are coupled to a shared object store system 230. A configuration module 220 containing the configuration of the stack and of each switch in the stack is also coupled to the shared object store system 230.

The shared object store system 230 detects the configuration of the switching stack on initialization and detects changes in stack, for example, the addition or removal of a switch or the change in the capabilities or configuration of a switch. This can be provided to the central control plane for determining how to provide firewall and other services capabilities to switches that do not have these capabilities.

### II. Switching Unit Architecture

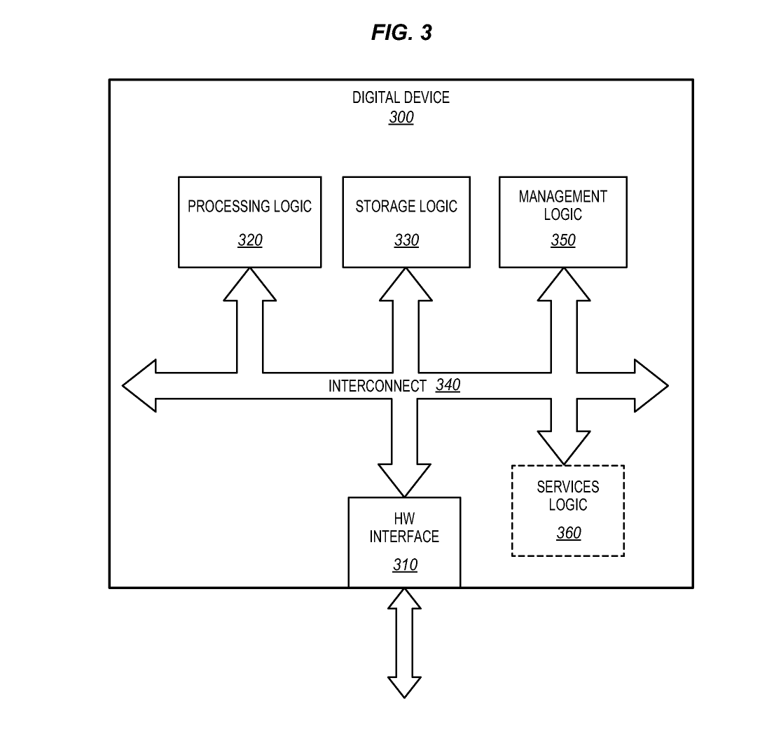

Referring to FIG. 3, an exemplary embodiment of a digital device 300 is shown in block diagram form. In accordance with one embodiment of the disclosure, the digital device 300 comprises a hardware external interface 310, processing logic 320 and storage logic 330, in which one or more of these logic units are coupled together via an interconnect 340.

The interface 310 enables the digital device 300 to communicate with other devices supporting wired and/or wireless connectivity. For instance, the interface 310 may be implemented as a wireless adapter (e.g., one or more radios, antenna(s) or the like) adapted to receive ingress messages and/or a wired adapter (e.g. connector) through which ingress messages are received over a wired interconnect.

Processing logic 320 is adapted with logic to classify ingress packets, assign priority to these classified ingress packets, route the ingress packets and provide any other packet processing. The packet processing logic analyzes the control payload of received messages (packets) such as (1) destination IP

(DEST IP) address, (2) source IP (SRC IP) address, (3) protocol, (4) destination port number (DEST PORT), and/or (5) source port number (SRC PORT). The payload is used with stored information corresponding to active processes running on the control plane of the digital device, to determine if the message is control, or data, and associated with an application.

As further shown in FIG. 3, storage logic 330 is volatile and/or non-volatile memory implemented within the digital device 300 and used by the processing logic 320. According to one embodiment of the disclosure, the storage logic 330 features content addressable memory (CAN) and/or random access memory (RAM) accessible by the processing logic 320.

As further shown in FIG. 3, the digital device also includes management logic 350 coupled to the interconnect 340 to provide chassis management, path routing management and internal system configuration using the storage logic. The digital device may also include additional services logic such as firewall logic 360 for network protection. Other services logic may provide deep packet inspection, session control, application control, crypto and encryption/decryption services, granular AAA and other services. The firewall logic may be used to inspect and handle packets received at the hardware interface 310. These packets may be routed by the packet processing logic 310 or returned to a source digital device 110 for further packet processing.

In one example the services capability is in the form of a separate removable hardware module, such as a services ASIC service module (FASM), however, the presence or absence of services capabilities may be in other forms. On initialization, an AS may perform a self-diagnostic to determine whether the FASM is present in the system.

### III. Intelligent Offloading in a Distributed Stacking Switching System

As described herein, services treatment may be consistently and automatically offloaded to other hardware whenever other hardware is available anywhere in a distributed stack. The offloading mechanism may be distributed throughout the stacking system even when the offload hardware engines are not local to the packet processing. The control plane treatment and control plane mechanism may also be offloaded using a two step mechanism for packet treatment.

The first one of the two step is an automatic classification of a packet for a security treatment type e.g. NAC for device fingerprinting. The second step is context mapping the policies to one or more available hardware engines in a stack. For this second step pipeline changes are modeled so that policies are applied sequentially.

The principles described herein apply to various types of services treatments. These treatments translate to appropriate policies in hardware and include but are not limited to:

1) Network access control for user and device profiling;
2) Firewall processing including:

a. Stateless permit and deny; and

b. Stateful actions including NAT, bandwidth contract, policing, QoS;

3) DPI for voice ALGs (Application Layer Gateways) and app visibility;
4) Services such as tunnel initiation/termination, fragmentation/reassembly, encryption/decryption, etc.
5) Deep traffic visibility,
6) Encryption/decryption services,
7) Granular AAA, and many others.

These treatments may apply to user/interface authentication and dynamic capability derivation based on roles, interface capabilities, and firewall enabled VLAN (Virtual Local Area Network).

In some examples provided in this description, the particular packet processing functionality that is detected and distributed is firewall functionality. However, the invention is not so limited. Similar techniques may be applied to many different functionalities that require substantial or specific processing resources or specific data resources. These functionalities may include deep packet inspection for certain applications, encryption and decryption of AP/station tunnel traffic, fragmentation and reassembly of oversized packets, network authentication mechanisms allowing users to authorize and have appropriate access control, and bandwidth contracts and rate limiting for certain types of traffic.

The two-step “treatment mechanisms” mentioned earlier are configured in control plane software upon initialization (such as interface, ACL (Access Control List) engine, etc.). They take effect upon arrival of the first packet from an unauthorized user or from an untrusted network interface.

While a “two-step” treatment is described herein, more or fewer steps may be used. Additional steps may be added and the two steps may be modified. Steps in the case of the “two step” treatment refers to sequential operations performed by network processors and is not used to suggest any legal meaning or connotation.

The first of the two steps or operations is the automatic classification of the security treatment. Certain underlying pipeline rules may be used to classify a treatment. The treatment may be to apply NAC, firewall, DPI, and other services to an ingress packet stream. The control plane configures ACL (Access Control List) rules on the existing fastpath (FP) or network-processor (NP) datapath pipelines. The treatments are applied sequentially and therefore may be independent of each other. The treatment may be applied by one or many special-purpose hardware engine, such as a services ASIC that is specifically configured for such treatments or by general purpose processor that have access to appropriate software or co-processors.

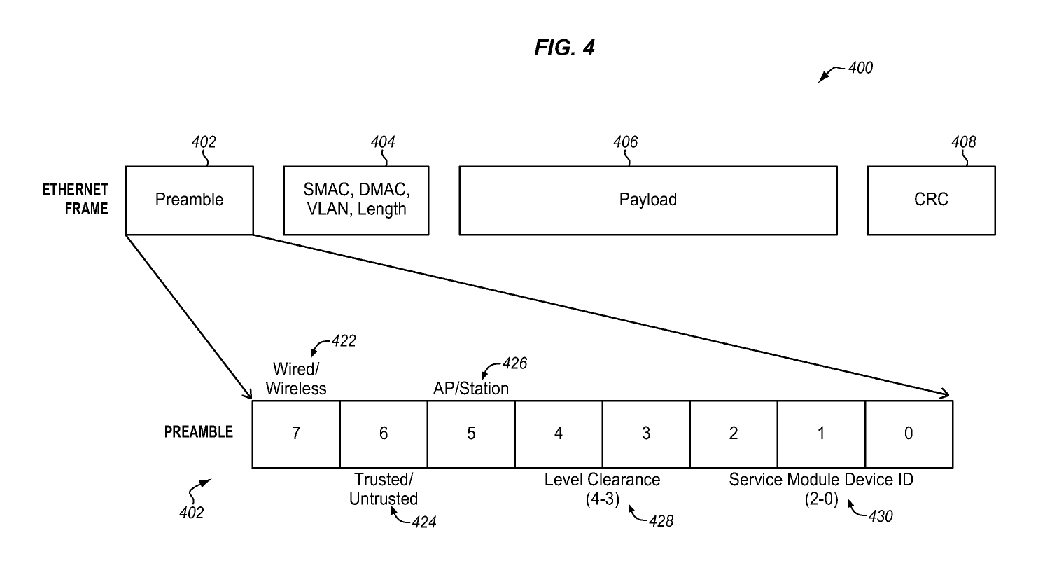

When packets are forwarded to a services module from a FP/NP, the packets carry an 8-bit context header in addition to a payload. FIG. 4A is a diagram of a packet 400 that includes a preamble 402, a context 404, a payload 406, and an error code 408, such as a cyclic redundancy check code. There may be more or fewer components to the package and the order of the components may be modified to suit different systems and applications. Some of the overhead portions 402, 404, 408 may be within the payload portion and the payload portion may be divided into separate sections. The error correction section 408 may be in two or more parts, depending on the implementation. The payload contains the data, configuration, or control information that is to be sent from the source address to the destination address.

As indicated the context may include different kinds of information, depending on the implementation. In this example, the context includes SMAC (Source Media Access Control), DMAC (Destination Media Access Control), VLAN (Virtual Local Area Network), and packet bit length information as examples. However, the context may include other or different information, depending on the particular implementation.

As an example, the context may include a Device OUI (Organizationally Unique Identifier) of 24 bits as the SMAC of an ingress packet undergoing treatment. A Device OUI may be prepended to an Ethernet header 404 when the packet is forwarded to a services module for processing.

The preamble 402 has a first field of 1-bit 422 to indicate whether the packet is for wired or wireless communication. A second 1-bit field 424 indicates whether the packet is from a trusted or an untrusted source. A third 1-bit field indicates whether the package is from an AP (Access Point) or a STA (remote Station). A fourth 2-bit field 428 indicates the clearance level of the package and a fifth 3-bit field 430 provides a service module ID.

The preamble 402 may be constructed in a variety of different ways to provide information bits as desired for any particular system implementation. In the present example 8 bits are used, however, more or fewer may be used. The order of the fields may be changed, the number of bits for each field may be changed and more or fewer or different fields may be used, depending on the particular implementation. While the example herein are presented as a preamble prepended to the header, the information may alternatively be appended to the end or the middle of the packet or added to the context header 404. The preamble as described herein is an additional separate header or tail section. This allows the information to be read and modified without affecting the rest of the packet.

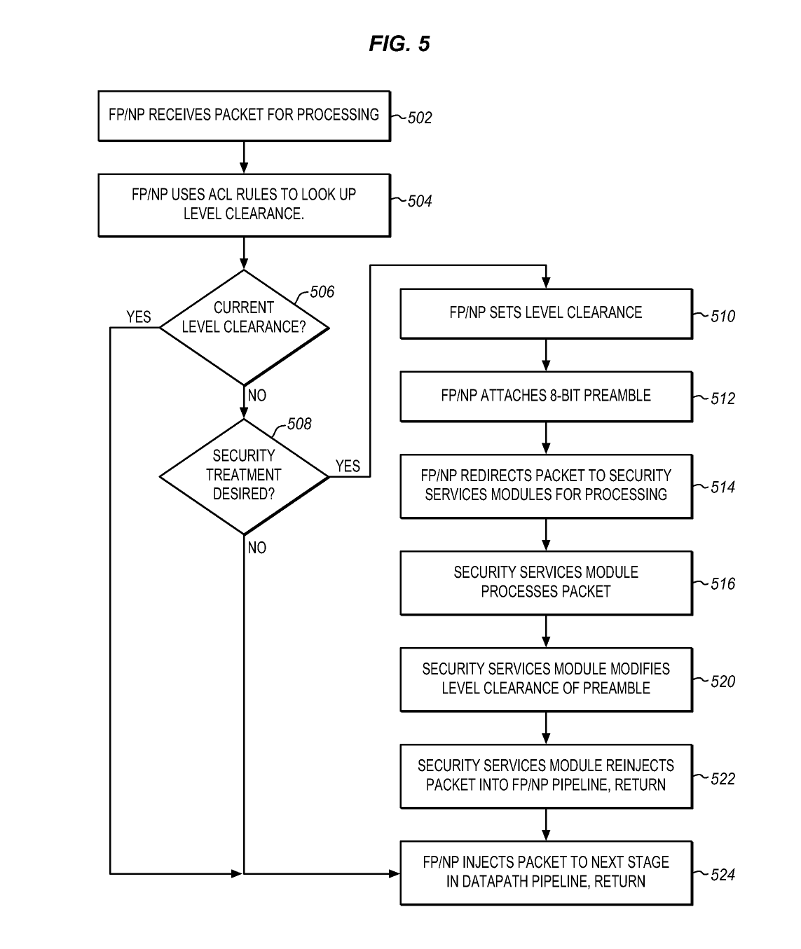

FIG. 5 is a process flow diagram of processing packets using a prepended preamble in the header according to an embodiment of the invention. In the classification process, first the control plane enables an automatic security or services treatment for the respective wired or wireless users and interfaces. This enables the FP/NP to generate the 8-bit preamble header, such as the preamble 402 of FIG. 4.

At 502 the FP/NP receives a packet for processing and for routing. At 504 the FP/NP accesses ACL rules to look up level clearances. If the current level is not e.g. 0x4 at 506 and if a security treatment is desired at 508 based on the rules, then the FP/NP sets the level clearance at 510 and prepends the 8-bit header at 512. Otherwise, the packet is injected back into the datapath at 522 for the next stage in processing. So if the packet is already fully processed or if no security treatment is desired, then the FP/NP forwards the packet to the next stage in the FP/NP pipeline.

The preamble prepended by the FP/NP at 512 depends on the treatment context such as the interface configuration. The FP/NP sets the level to some level, e.g. 0x0 for the first stage in processing, and then redirects the packet to an appropriate hardware services module for processing at 514.

A security service module will receive the packet from the FP/NP for processing and then process the packet at 516 based on the level clearance and any other factors depending on the particular implementation. After the processing is completed, then the security service module will modify the preamble. In the example of FIG. 4 the level clearance 428 will be modified to indicate that this processing has been performed. The packet with the modified preamble is then re-injected into the FP/NP pipeline at 520 with the modified level clearance. As an example, if the level clearance was set to 0x0 by the FP/NP, then it might be set to 0x2 for levels 1-2. The next stage in the datapath pipeline may be bridging, routing, or any other stage, including additional security processing, depending on the particular implementation.

### IV. Context Mapping Mechanism

The second step of the two-step method mentioned above is the operation of a context mapping mechanism. The preamble described herein allows a mechanism by which packets may be redirected for any type of security or other services treatment. The appropriate hardware engine may be distributed anywhere in the stack. Using the control plane, it has a record of the available hardware engines, (there may be or more of each type in any stack), the types of treatments provided by each of the engines, and the path to reach each one in the stack. As described herein, the control plane may use a context-mapping mechanism to generate a 3-tuple mapping model.

In one example, a 3-tuple may be formed of {context, availability, treatment} and this 3-tuple may be mapped to specialized hardware-specific policy primitives.

The context may include: wired or wireless; trusted or untrusted; AP or station; user; and device types; etc. This information may be encoded in 32 bits.

The availability may include a special-purpose security hardware ASIC or other type of engine in the stack. 1 bit may be used for each type.

The treatment defines the packet processing that is to be performed. This may include NAC (Network Access Control), firewall, DPI (Deep Packet Inspection), encryption, decryption, and other services. 2 bits are used to define the different options.

The policy primitives include the lookup-action. Many different security or firewall treatments are possible with a general-purpose lookup-action mechanism. In one embodiment the hardware service module is responsible to match the context device number with its configured number for validation.

Some examples of general types of applicable lookup-actions are shown in the Table

TABLE

| Lookup | Applicable Action |
|---|---|
| User SMAC | User authentication, access control |
| Device OUI | Device authentication |
| Level clearance | Trigger next level forwarding |
| 5-tuple session | Firewall, Policing/Bandwidth Control, |
| | Network Address Traversal, DPI |

Rather than performing authentication and access control at the control plane, it is possible to offload some or all of the internal and stateful authentication from the control plane. This internal and stateful authentication may include things like user identification, device profiling such as OUI for wireless and untrusted port/SMAC for wired interfaces. Other functions, such as learning, may be handled better in the control plane. Still other functions, such as stateful access control policies may be handled better in services hardware as described above in the context of the context mapping mechanism above. For external authentication such as 802.1x or RADIUS (Remote Authentication Dial-In User Service)-based authentication, the control plane may still be used.

The techniques described herein may be applied to any of a variety of package processing pipelines. An existing FP/NP using ACL may be adapted to redirect packets to specialized security services and to obtain responses from the services. A services-enabled VLAN may be used by configuring port members of a services-enabled VLAN(s) to undergo stateful fire-wall processing or DPI. This may be done by adding interface/VLAN ACL rules before the bridging stage, so that unicast/multi-destination traffic is redirected. Such a technique avoids an explicit configuration for enabling services functions on an interface or on a VLAN. At the same time session ACLs may be applied explicitly on an interface or to a user-role.

### V. Example Switching Stack

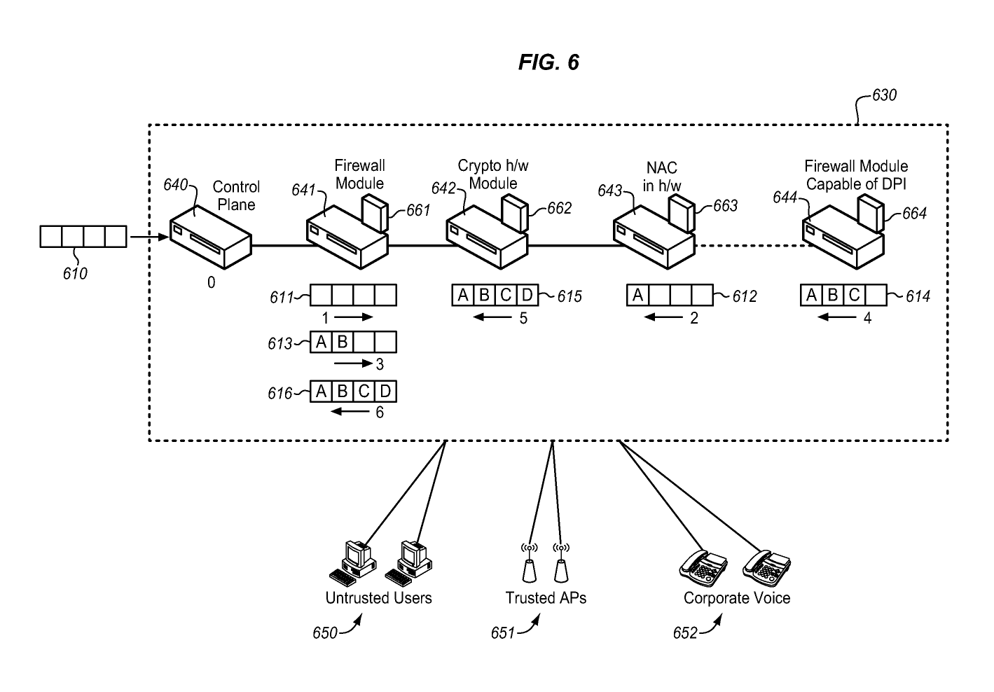

FIG. 6 is a diagram of a switching stack similar to that of FIG. 1 in which multiple specialized firewall or security service processors are provided at different locations in the stack. The general configuration of the switching devices and the connections to other devices is similar to that of FIG. 1. The switching stack 630 includes multiple network devices of which five 640, 641, 642, 643, 644 are shown. At least one of the network devices is configured to forward packets to another network device for firewall/security processing or servicing.

Typically a device that does not have services capability or that has an absence of services capability will forward packets to a device that is in the subset of devices that has firewall/security/other services processing. The second device will receive the packet, perform the services processing, and then either remove the packet as unsafe or return it to the first device for forwarding. The network device may be configured by sending a configuration file to the device or by sending network topology information to the device and allowing the device to configure its own paths. The configuration may be only for firewall or security processing or it may include other path and routing information.

As shown in FIG. 6, a packet 610 arrives at the control plane and is then forwarded to the other network devices or NPs (network processors) for processing. Each of the other NPs have specialized firewall/security functionality. This may be provided by an additional hardware or software module. In the illustrated example, the first NP 641 has an installed firewall module 661. The second NP 642 has an installed encryption hardware module 662. The third NP 643 has an installed NAC hardware module 663. The fourth NP 644 has an installed firewall module with DPI 664. Many other types of services modules are possible and the NPs that include these modules may not be local. In addition, there may be many NPs that do not have any specialized firewall/security/other services functionality.

The central control plane may identify all of the NP and any specialized functionality by receiving identification, registration, or presence advertisement packets from the various network devices of the switching stack. The control plane may receive additional advertisements or use the advertisements already received to identify all of the network devices and determine which ones are in the subset with services capability. This information may be used to send configuration information to each device or to send enough information that the network device can configure itself. In addition, the information may be used to route packets and to append packet preambles.

While six access switches, network devices, or NPs are shown, there may be more or fewer, depending on the particular implementation. The NPs serve one or more external clients or client ports using a wired or a wireless connection or both. The switching stack 630 is also coupled to any of a variety of different client end connections and types, such as trusted or untrusted user devices 650, trusted and untrusted wireless access points 651, and voice terminals 652.

The packet 610 arrives at the control plane 640 without any preamble 402 of the type shown in FIG. 4. At the control plane 641, the packet is analyzed to determine which treatments are to be applied. This may be done using ACL rules to find lookup/actions, by some type of packet analysis, or in any other way. The packet is then forwarded to a firewall processor for treatment.

Based on the preamble which identifies a level clearance and service module ID, the packet is sent to the identified service module. In the illustrated example, the packet is first sent to an NP 641 with a firewall module 661. This module attaches a preamble 611 to the packet with routing for each of the treatments that will be applied.

The packet is sent from the firewall NP to an NP 643 with a specialized module 663 for NAC functionality. The packet 612 is treated and its preamble is altered to show that the level clearance is incremented. The change to the preamble is shown by adding a sequence “A” of level clearance bits. The packet is returned to the firewall NP 641. Another treatment is applied at the firewall NP and the preamble of the packet 613 is altered by adding sequence “B” to show the change in level clearance and the service module for the next treatment.

In the diagram of FIG. 6, a four block rectangle is used to indicate the status changes to the packet. The four block rectangle does not directly correspond to any particular part of the packet or to any particular bits in the packet or the preamble. While a packet preamble is used here to track the changes, the changes may be tracked using another part of the packet, depending on the particular implementation.

The packet is forwarded to an NP 644 with a firewall module capable of DPI 664. The NP performs the DPI and increments the level clearance as shown by adding bit sequence “C.” The packet is then sent for encryption to an NP 642 with an encryption module 662. The preamble is again modified by adding bit sequence “D” and the packet 615 is returned to the original firewall NP 641 which returns the packet to the control plane 640. The control plane is then able to inject the packet to the next stage in the datapath pipeline.

The appended preamble allows all of the packet treatments to be applied in the intended order by a combination of classifying the packet and mapping the context. The preamble provides the level clearance and allows the level clearance to be incremented as the packet is processed. The preamble also provides a service module device ID which allows the packet to be treated by any NP in the stacked system. The control plane or another NP defines which service module performs each function using the service module ID.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as determined by the appended claims and their equivalents. For instance, any one or more of the described packet processing functionalities may be detected and packets may be forwarded to one or more different network devices for packet processing. Packet processing functionalities may be performed by dedicated hardware by software or by a combination. The described techniques may be applied to a variety of different types of network devices working in different combinations. The description is thus to be regarded as illustrative instead of limiting.

What is claimed is:

1. A non-transitory computer readable medium comprising instructions which, when executed by one or more hardware processors, causes performance of operations comprising:
receiving a packet comprising a packet header indicating that a first treatment is needed to be applied to the packet;
applying the first treatment to the packet;
modifying the packet header, to indicate that the first treatment is no longer needed to be applied to the packet, to obtain a modified packet header;
subsequent to applying the first treatment, forwarding the packet with the modified header.

2. The medium of claim 1, wherein receiving the packet is performed by a first module of a device and wherein forwarding the packet comprises the first module forwarding the packet to a second module of the device from which the packet was received.

3. The medium of claim 1, wherein receiving the packet is performed by a first module of a device and wherein forwarding the packet comprises the first module forwarding the packet to a second module of the device which is different from a third module of the device from which the packet was received.

4. The medium of claim 1, wherein receiving the packet is performed by a first module of a device, and further comprising:
prior to the first module receiving the packet:
determining, by a second module, a plurality of treatments needed to be applied to the packet;
generating, by the second module, the packet header for the packet to indicate the plurality of treatments needed to be applied to the packet;
forwarding, by the second module, the packet with the packet header to the first module.

5. The medium of claim 4, wherein the second module is implemented by the device implementing the first module.

6. The medium of claim 4, wherein the second module determines the plurality of treatments based on context information included in the packet.

7. The medium of claim 4, wherein the second module determines the plurality of treatments based on available resources.

8. The medium of claim 1, wherein the treatment comprises one of: Network Access Control (NAC), firewall, Deep Packet Inspection (DPI), encryption, or decryption.

9. The medium of claim 1, wherein the packet header identifies a specific order of treatments needed to be applied to the packet.

10. The medium of claim 1, wherein forwarding the packet comprises forwarding the packet to a module that can apply a treatment still needed to be applied to the packet.

11. A device comprising:
a hardware processor;
the device configured to perform operations comprising:
receiving, by a first module of the device, a packet comprising a packet header indicating that a first treatment is needed to be applied to the packet;
applying, by the first module, the first treatment to the packet;
modifying the packet header by the first module, to indicate that the first treatment is no longer needed to be applied to the packet, to obtain a modified packet header;
subsequent to applying the first treatment: forwarding, by the first module, the packet with the modified header.

12. The device of claim 11, wherein forwarding the packet comprises the first module forwarding the packet to a second module of the device from which the packet was received.

13. The device of claim 11, wherein forwarding the packet comprises the first module forwarding the packet to a second module of the device which is different from a third module of the device from which the packet was received.

14. The device of claim 11, wherein the operations further comprise:
prior to the first module receiving the packet:
determining, by a second module, a plurality of treatments needed to be applied to the packet;
generating, by the second module, the packet header for the packet;
forwarding, by the second module, the packet with the packet header to the first module.

15. The device of claim 14, wherein the second module is implemented by the device implementing the first module.

16. The device of claim 14, wherein the second module determines the plurality of treatments based on context information included in the packet.

17. The device of claim 14, wherein the second module determines the plurality of treatments based on available resources.

18. The device of claim 11, wherein the treatment comprises one of: NAC; firewall; DPI; encryption; or decryption.

19. The device of claim 11, wherein the packet header identifies a specific order of treatments needed to be applied to the packet.

20. The device of claim 11, wherein forwarding the packet comprises forwarding the packet to a module that can apply a treatment still needed to be applied to the packet.
